(19) United States
(12) Patent Application Publication
(10) Pub. No.: US 2019/0381475 A1
(43) Pub. Date: Dec. 19, 2019

(54) PLASMA REACTOR AND METHOD OF OPERATING A PLASMA REACTOR

(71) Applicant: CCP TECHNOLOGY GMBH, München (DE)

(72) Inventor: Olaf Kühl, Greifswald (DE)

(21) Appl. No.: 16/464,755

(22) PCT Filed: Nov. 30, 2017
(86) PCT No.: PCT/EP2017/081029

§ 371 Date: May 29, 2019

(30) Foreign Application Priority Data
Dec. 2, 2016 (DE) 10 2016 014 362.2

(51) Int. Cl. B01J 19/08; B01J 19/00; C01B 32/205; C01B 3/24

(52) U.S. Cl. CPC B01J 19/088; B01J 19/002; C01B 32/205; C01B 3/24; B01J 2219/0898; C01B 2203/1235; B01J 2219/0839; B01J 2219/00162; B01J 2219/00245; C01B 2203/0272; B01J 2219/0801

(57) ABSTRACT

The problem addressed by the invention is that of providing a plasma reactor for decomposition of hydrocarbons which allows stable operation over a prolonged time period. This problem is solved by a plasma reactor for decomposing a hydrocarbon fluid, which comprises a reactor chamber surrounded by a reactor wall and further comprises at least one hydrocarbon inlet and an outlet. A plasma torch having at least two electrodes, which comprise a base part at a first end, is fixed to the reactor wall. At a second end, the electrodes comprise a burner part which projects into the reactor chamber, and a plasma zone is defined between the burner parts of adjacent electrodes. In a region between the plasma zone and the outlet, the hydrocarbon inlet opens into the reactor chamber, and the hydrocarbon inlet is oriented toward the plasma zone such that hydrocarbon fluid flowing therefrom is directed towards the plasma zone. In the plasma reactor disclosed herein, primarily small C particles are formed which prevent fouling or overgrowing of the reactor chamber. Furthermore some large and heavy C particles, which may statistically be formed, penetrate the plasma cloud and can attach specifically to the electrodes.

### RELATED APPLICATIONS

This application corresponds to PCT/EP2017/081029, filed Nov. 30, 2017, which claims the benefit of German Application No. 10 2016 014 362.2, filed Dec. 2, 2016, the subject matter of which are incorporated herein by reference in their entirety.

### BACKGROUND OF THE INVENTION

The present invention relates to a plasma reactor and a method of operating a plasma reactor for decomposing a hydrocarbon fluid.

U.S. Pat. No. 5,997,837 A1 describes a known plasma reactor which, in the 1990s, was used as an experimental reactor for the production of carbon particles or C particles. The known plasma reactor comprises a reactor chamber which is enclosed by a reactor wall. A plasma torch which has annular electrodes is fixed at the reactor wall. The plasma torch has a burner part which projects into the reactor chamber. In the center of the annular electrodes, there is a central hydrocarbon inlet which is adapted to feed a hydrocarbon fluid in the axial direction. The reactor chamber is substantially cylindrical, and a plurality of radially oriented additional hydrocarbon inlets are provided on its outer wall. At the other end of the reactor chamber, opposite the plasma torch, the plasma reactor comprises an outlet through which the substances resulting from the decomposition of the introduced hydrocarbon fluid can escape. During operation of the known plasma reactor, an annular plasma is formed on the burner part along the annular electrodes when considered averaged over time. A hydrocarbon fluid is supplied to the central region of the annular plasma via the central hydrocarbon inlet. At operating temperatures of up to 2000° C., the hydrocarbon fluid is decomposed into hydrogen and carbon particles. Additional hydrocarbon fluid is supplied via the additional radially directed hydrocarbon inlets and is decomposed into additional hydrogen and additional carbon. The additional carbon attaches to the already existing C particles and produces larger C particles. The C particles and the hydrogen exit from the outlet of the plasma reactor as H₂/C aerosol. A similar system is described in WO 93/20152.

A major problem concerning the decomposition of hydrocarbons into C particles and hydrogen is the uncontrolled deposition of C particles (so-called fouling) on the walls of the reactor chamber and on other parts of the device. While fouling results in solid carbon deposits or crusts that are difficult to remove, an attachment of loose C particles (so-called sediments) is less of a problem as these loose sediments either detach by themselves during operation or can be easily mechanically removed, e.g. by scratching or brushing. Predicting the occurrence of fouling has heretofore been difficult, and the phenomenon has been insufficiently understood in the art. In the known plasma reactors in some cases, so much carbon has been deposited on the walls of the reactor chamber within a few minutes that the reactor chamber was “overgrown” and the operation had to be stopped. On the other hand, erosion of the electrodes occurred in plasma reactors with electrodes made of graphite, which also led to the termination of the operation.

### SUMMARY OF THE INVENTION

It is the object of the invention to provide a plasma reactor for the decomposition of hydrocarbons, which allows a stable operation over a longer period.

This object is achieved by a plasma reactor for decomposing a hydrocarbon fluid, wherein the plasma reactor comprises a reactor chamber, which is surrounded by a reactor wall and has at least one hydrocarbon inlet and one outlet, A plasma torch having at least two electrodes, which have a base portion at a first end, is attached to the reactor wall. At a second end, the electrodes have a burner part which projects into the reactor chamber, and a plasma zone is defined at the end of the burner parts of adjacent electrodes. In operation, an electrical voltage is applied between the electrodes, whereby a plasma is generated at the end of the burner parts. In a region between the plasma zone and the outlet, the hydrocarbon inlet opens into the reactor chamber, and the hydrocarbon inlet is oriented with respect to the plasma zone such that outflowing hydrocarbon fluid is directed towards the plasma zone.

The choice of this particular way of feeding directly towards the plasma zone, also referred to as head-on-feeding, achieves the advantageous effect that the introduced hydrocarbons (preferably methane, natural gas, etc.) decompose in the vicinity of the arc at extremely high temperatures. Near the arc of the plasma torch and within the plasma the temperature is above the sublimation temperature of carbon and above the decomposition temperature of hydrogen. In the case of methane as a gaseous hydrocarbon, a five-fold increase in the gas volume is caused (CH₄->C+4H), since one methane molecule decomposes into five gaseous single atoms. If heavier hydrocarbons having longer C chains are supplied, the gas volume is multiplied even more (CₙHₘ->nC mH). As hydrocarbon fluid (e.g. methane) continuously flows during operation, the substances C and H (product gas) must flow to the side. Because of the reactor wall, the product gas composed of C and H can not flow away fast enough, and there is a stagnation of the very hot product gas immediately before the arc of the plasma torch. This cloud of hot product gas is partially penetrated by inflowing hydrocarbon fluid and heats the hydrocarbon fluid by convection and radiation to several thousand degrees Celsius before it is discharged to the side and, thereafter, flows down at the outside in the vicinity of the reactor wall towards the exit of the plasma reactor. In this process, the product gas composed of C and H transfers heat to the rising hydrocarbon fluid in the center of the reactor chamber in counterflow.

From the carbon of the product gas, carbon particles (carbon black, activated carbon) are formed mainly by aggregation of local concentrations of carbon atoms from the gas phase. In the plasma reactor disclosed herein, mainly small C particles are produced, which prevent fouling or overgrowth of the reactor chamber. Furthermore, some large and heavy C particles, which may be formed statistically, penetrate through the plasma cloud and can attach specifically to the electrodes. Thus, material loss of the electrodes by erosion is compensated. Consequently, the plasma reactor described herein can achieve significantly longer periods of operation without interruption compared to the prior art.

In particular, in the case of the plasma reactor where an outlet direction is defined by a line from the plasma zone towards the outlet, the hydrocarbon inlet is oriented in the direction opposite to the outlet direction. The cloud of hot product gas is compressed between the incoming hydrocarbon fluid from the hydrocarbon inlet and the plasma at the burner part, thereby accelerating a flow direction towards the reactor wall. As a result, only a few C atoms can aggregate, and only small C particles will be formed.

When graphite electrodes are used for the plasma torch, these graphite electrodes are designed to operate at least at their tip hotter than 2800° C. (a temperature at which graphite has a non-negligible vapor pressure) but colder than 3900° C. (a temperature at which graphite sublimes). In one method of operation, at least the supply of electrical energy to the graphite electrodes and the inlet pressure and rate of introduction of the hydrocarbon fluid are controlled such that the temperature at the tip is hotter than 2800° C. but colder than 3900° C.

In a known plasma reactor, for example according to U.S. Pat. No. 5,997,837 A1, the temperature at the tip of the plasma torch was not precisely controlled, At temperatures above 3900° C., gaseous carbon is generated, which evaporates from a graphite electrode. Further, as a flow is generated in the reactor chamber from the electrode toward the outlet during operation, the gaseous carbon (the partial pressure of the graphite) is continuously discharged toward the outlet by this flow. The inventors have found that, in the known plasma reactor, the electrode erodes at its hottest zones (especially at the tip) for this reason. The introduction of the hydrocarbon fluid directly toward the plasma zone (head-on-feeding) results in the advantageous effect that the partial pressure of gaseous carbon in the vicinity of the electrode is increased. Consequently, the partial pressure is no longer maintained by evaporation of the electrode, and the erosion of the electrode is stopped. However, when the vapor pressure of the carbon at the electrode becomes too high, the carbon re-sublimes on the electrode because the temperature of the electrode is below the sublimation temperature of the graphite.

Advantageously, the hydrocarbon inlet of the plasma reactor is formed by a conduit fixed to the reactor wall at a first end and having a hydrocarbon fluid discharge opening at an opposite second end, and the conduit is formed in such a way that the discharge opening for hydrocarbon fluid is directed to the plasma zone. In this way, the introduction of hydrocarbon fluid into the reactor chamber can be carried out in a simple manner, and the conduit can be additionally cooled, if cooling by the introduced hydrocarbon fluid is not sufficient.

In one embodiment, the hydrocarbon inlet of the plasma reactor is formed by a bundle of hydrocarbon conduits, wherein the bundle of hydrocarbon conduits is attached to the reactor wall at a first end, and wherein each hydrocarbon conduit has a discharge opening for hydrocarbon fluid at an opposite second end. In this case, the bundle of hydrocarbon conduits is shaped such that each of the discharge openings for hydrocarbon fluid is oriented toward the plasma zone. Further, the output of hydrocarbon fluid from the individual hydrocarbon conduits of the bundle may be controlled separately. Thus, the output of hydrocarbon fluid (i.e. the introduction into the plasma reactor) may be varied over a wide range, e.g. with respect to: mass per time, pressure of the hydrocarbon fluid before the discharge opening (upstream pressure), flow velocity at the discharge opening.

Furthermore, it is advantageous if each of the individual hydrocarbon conduits has respective discharge openings having a flow area of different size. With a constant mass flow, this allows to change the flow velocity of the hydrocarbon fluid. Alternatively, at a constant flow velocity, the mass flow can be changed. These possibilities for changes again influence the size of the C particles and their momentum. In addition, it is possible in this embodiment to regulate the carbon partial pressure at the electrode in such a way that, on the one hand, increased deposition does not occur (partial pressure is too high) and on the other hand also no erosion of the electrode occurs (vapor pressure is too low). For the nozzle having the largest flow area, the pressure and the flow rate are controlled such that the cloud of hydrocarbon fluid comes close to the electrode tips. For the smaller nozzles, the pressure and the flow rate are controlled in such a way that the edges of the hydrocarbon fluid cloud are directed toward the tip of the electrode (fine adjustment).

In particular, it is advantageous when the flow areas of the hydrocarbon conduit discharge openings are different, wherein an output of hydrocarbon fluid from a first hydrocarbon conduit having a first discharge opening can be varied via valves over a first output range for hydrocarbon, and wherein an output of hydrocarbon fluid from at least one second hydrocarbon conduit having a corresponding second discharge opening can be varied by means of valves over at least one second output range for hydrocarbon fluid, wherein the at least one second output range is at least partially different from the first output range for hydrocarbon fluid. In this case, the first output range and the at least one second output range cooperatively constitute an entire output range for hydrocarbon fluid of the hydrocarbon inlet. Thus, the output parameters can be varied over a wide range without interrupting the operation of the plasma reactor. Thus it is also possible to carry out experiments on optimum operating parameters for the plasma reactor. In addition, the plasma reactor can be adjusted for different hydrocarbons and for varying operating conditions.

In one embodiment, the plasma reactor comprises an apparatus for measuring a particle size. Thus, a controller of the plasma reactor may regulate the operating parameters depending on the particle size. Further, if the particle size is continuously measured, and at the same time individual operating parameters are changed, a map can be created which represents the relationship between the particle size and the various operating parameters.

Further, the plasma reactor may include a pressure sensor configured to sense the pressure in the reactor chamber (corresponding to the back pressure against the upstream pressure (pre-pressure) upstream of the discharge opening). The inventors have found that a strong change of the pressure in the reactor chamber is an indication that a setting of operating parameters has been achieved where the product gas of C and H (described above) and the desired flow toward the wall of the reactor chamber occur. Thus, by means of a simple pressure sensor, a setting can be achieved in which small C particles are present.

The object of the invention is further achieved by a method for operating a plasma reactor, wherein the plasma reactor is configured for decomposing a hydrocarbon fluid and comprises a reactor chamber, which is enclosed by a reactor wall and has at least one hydrocarbon inlet and one outlet. A plasma torch having at least two electrodes is disposed in the reactor chamber, and a plasma zone is defined between adjacent elongate electrodes. The method comprises the steps of: introducing hydrocarbon fluid toward the plasma zone into a region of the reactor chamber between the plasma zone and the outlet, and decomposing the hydrocarbon fluid into carbon particles and hydrogen; varying at least one parameter of introduction of hydrocarbon fluid; determining a correlation between a particle size of the carbon particles and the at least one parameter of hydrocarbon fluid introduction during the varying step. Further, if the particle size is continuously measured and, at the same time, individual operating parameters are varied, a map can be created which represents the relationship between the particle size and the various operating parameters. From the correlation between particle size and the at least one parameter for introduction of hydrocarbon fluid, parameters can be selected which cause production of mainly small C particles which prevent fouling or overgrowth of the reactor chamber. Likewise, large and heavy C particles can be generated selectively, which penetrate through the plasma cloud and attach specifically to the electrodes so as to compensate for a loss of material of the electrodes by erosion. Furthermore, an setting of operating parameters is considered, where some large and heavy C particles are generated statistically which compensate for the loss of material of the electrodes. Consequently, the method described here achieves significantly longer periods of operation without interruption when compared to the prior art.

Advantageously in this method, the operating parameter for introducing the hydrocarbon fluid is at least one of the following:
a flow area of the hydrocarbon inlet (with constant mass flow, the flow velocity of the hydrocarbon fluid can be changed in this way and, alternatively, the mass flow can be changed at a constant flow velocity);
a pressure difference between (i) a pressure of the hydrocarbon fluid at a position upstream of the hydrocarbon inlet and (ii) a pressure in the reactor chamber or a pressure downstream of the outlet (thus, the mass flow and the flow velocity can be changed, in particular fine tuned);
a flow velocity of the hydrocarbon fluid at the hydrocarbon inlet (the flow velocity may be influenced by changing the flow area of the hydrocarbon inlet or by changing the mass flow).
   These changes in the set operating parameters influence the size of the C particles and their momentum.

Preferably, the method includes the step of controlling the at least one parameter of the introduction of hydrocarbon fluid based on the determined correlation such that the particle size of the carbon particles is minimal. Experiments have shown that no hard or solid deposits (fouling) occur when the generated C particles are small. The size of the C particles depends on the length of the time interval in which the growing C particle encounters hydrocarbon molecules which can be thermally decomposed. In the absence of thermally decomposable hydrocarbon molecules, the size also depends on the spatial availability of C atoms which can be agglomerated, i.e. the availability of C atoms in close proximity, which can combine to form a C particle. This spatial availability can be increased by turbulent flow. Particle growth comes to an end when no further C atoms are available in the relevant volume segment. The C particles have a graphit-like structure, and individual C particles can still aggregate into clusters (non-elastic impact), which do not form hard or solid structures and deposits.

In one embodiment of the method, a pressure difference between (i) a pressure of the hydrocarbon fluid at a position upstream of the hydrocarbon inlet and (ii) a pressure in the reactor chamber or a pressure at a position downstream of the outlet is continuously sensed, and a sudden change in the sensed pressure difference. It has been found that a sudden change in the pressure or in the pressure gradient inside the reactor chamber is an indication that a setting of the operating parameters has been achieved where the product gas composed of C and H (described above) and the desired flow toward the wall of the reactor chamber occur, Thus, by means of a monitoring of the pressure curve, a setting can be achieved in which small C particles are present.

Preferably, the pressure in the reactor chamber and the temperature outside the plasma zone are kept slightly below the conditions for sublimation of graphite (about 3900° C. at 20 bar), in particular the pressure in the reactor chamber is kept at 20 bar and the temperature outside the plasma zone is kept below 3900° C. In this case, formation of particles occurs immediately and is essentially completed before the formed C particle arrives near the reactor wall. When the formation of particles is complete and no undecomposed hydrocarbon (e.g. natural gas or methane) is present, the formed C particle does not tend to deposit (i.e. condense) on the reactor wall.

In one embodiment, the hydrocarbon inlet is formed by a bundle of hydrocarbon conduits, the bundle of hydrocarbon conduits being attached to the reactor wall at a first end, and each hydrocarbon conduit having a discharge opening for hydrocarbon fluid at an opposite second end. In this case, the discharge openings for hydrocarbon fluid are oriented toward the plasma zone and they have discharge openings with different flow areas. In this case, the method includes the step of separately controlling the output of hydrocarbon fluid from the hydrocarbon conduits. Thus, the output of hydrocarbon fluid can be varied over a wide range, e.g. with respect to the mass per time, the pressure, the flow velocity.

The output of hydrocarbon fluid may be varied over a still wider range when a process is used, wherein the hydrocarbon inlet comprises a bundle of at least N hydrocarbon conduits and wherein the following steps are performed, wherein the mass flow of the hydrocarbon fluid in steps a) and b) is the same:

a) introducing a hydrocarbon fluid from the discharge openings of N hydrocarbon conduits, wherein a first pressure difference exists between (i) a pressure of the hydrocarbon fluid at a position upstream of the hydrocarbon inlet and (ii) a pressure in the reactor chamber or a pressure at a position downstream of the outlet;
b) introducing a hydrocarbon fluid from the discharge openings of N−1 or N+1 hydrocarbon conduits, wherein a second pressure difference exists between (i) a pressure of the hydrocarbon fluid at a position upstream of the hydrocarbon inlet and (ii) a pressure in the reactor chamber or a pressure at a position downstream of the outlet, wherein the second pressure difference is greater than the first pressure difference.

The erosion of the electrodes can be reduced or prevented if, in the method, a distribution of the size of the carbon particles based on the correlation is influenced such that a small part of the carbon particles is sufficiently large to travel through the plasma zone. Then, a portion of these carbon particles will be deposited on the ends of the electrodes. Further, the time period of introducing hydrocarbon fluid and the thickness of deposition of the carbon particles on the electrode ends are measured during this time. The course of the deposition of carbon on the electrode can be monitored inter alia by continuously measuring the electrical resistance at the electrode. The flow velocity, at which the hydrocarbon fluid is introduced, is then modified such that the deposition of the carbon on the electrode ends is as fast as the erosion of the electrode ends due to sublimation of the carbon at high temperatures. In particular, there are benefits when the distribution of the size of the carbon particles is influenced by means of the following parameters of the supply of hydrocarbon fluid:
Flow area of the hydrocarbon inlet;
Pressure difference between (i) a pressure of the hydrocarbon fluid at a position upstream of the hydrocarbon inlet and (ii) a pressure inside the reactor chamber or a pressure downstream of the outlet; and
Flow velocity of the hydrocarbon fluid at the hydrocarbon inlet.
   A change in these parameters of the output of hydrocarbon fluid influences the size of the C particles and their momentum, such that it is possible to specifically generate C particles which have sufficient size and sufficient kinetic energy or momentum to go through the plasma zone and reach the electrodes.

By means of the described arrangement of the introduction of hydrocarbon fluid and by varying the output of hydrocarbon fluid, the size of the C particles can be adjusted, and it is possible to counteract the erosion of the electrodes. This arrangement is an improvement over the prior art, where the introduction of hydrocarbon fluid into the reactor chamber could heretofore be varied only with respect to the pressure in a small range and erosion of the electrodes has occurred. Thus, by means of the orientation of the hydrocarbon inlet (i.e. the discharge opening(s)), also large C particles having high kinetic energy can enter the plasma zone and travel through the plasma zone. At the same time, after sublimation at or in the plasma zone (at a temperature greater than the sublimation temperature of carbon), small and medium sized C particles transform into very small C particles because no further hydrocarbon (e.g. natural gas or Methane) can decompose in the vicinity of these C particles, Thus, the size of the C particles, which flow laterally to the reactor wall and then down to the outlet of the present plasma reactor, is smaller than in known plasma reactors.

### BRIEF DESCRIPTION OF THE DRAWINGS

The invention as well as further details and advantages thereof will be explained with reference to Figs. based on preferred embodiments.

FIG. 1 shows a plasma reactor for decomposing a hydrocarbon fluid according to an embodiment of the present disclosure;

FIG. 2 shows a plasma reactor for decomposing a hydrocarbon fluid according to another embodiment of the present disclosure:

FIG. 3 shows a sectional detail Z of a hydrocarbon inlet for a plasma reactor according to an embodiment;

FIG. 4a shows a sectioned detail Z of an alternative hydrocarbon inlet for a plasma reactor according to one embodiment;

FIG. 4b shows a plan view of the detail Z from FIG. 4a;

FIG. 5 shows the plasma reactor according to one of the described exemplary embodiments in operation.

### DESCRIPTION

In the following description, the terms top, bottom, right and left and similar terms refer to the orientations shown in the figures or to arrangements and these terms are only intended for describing the embodiments. These terms may show preferred arrangements, but are not to be construed in a limiting sense. The hydrocarbon fluid described herein is preferably natural gas, methane, liquefied gas, biogas, heavy oil, synthetic hydrocarbons or a mixture thereof (more preferably from a stream of conventional or non-conventional natural gas and liquefied gases, also referred to as “wet gases”). Preferably, the hydrocarbons are directed into the reactor in gaseous form. Prior to introduction into the reactor, hydrocarbons which are liquid or highly viscous under normal ambient conditions may be converted in a gaseous form, may be diluted, or may also be introduced in a finely atomized form. All of these forms are referred to herein as hydrocarbon fluid.

The plasma reactor 1 according to the present disclosure has a reactor chamber 2 enclosed by a reactor wall 3 having a base 3a and a lid 3b. The reactor chamber 2 may also be divided at a different location than shown in the figures. The reactor chamber 2 is substantially cylindrical and has a central axis 4. The plasma reactor 1 further comprises at least one hydrocarbon inlet 5 connected with a reservoir (not shown) for a pressurized hydrocarbon fluid (for example with a tank and/or a pump). Attached to the lid 3b of the reactor wall 3 is a plasma torch 7 which has elongated electrodes (not shown in more detail). The plasma torch 7 has a base part 9, which is attached to the reactor wall 3 (here at the lid 3b). In the vicinity of the base part 9, a plasma gas inlet 10 is provided. At the other end at a free end of the electrodes opposite to the base part 9, the plasma torch 7 has a burner part 11, which projects into the reactor chamber 2. The electrodes, which are not shown in greater detail in the figures, are preferably tubular electrodes or tube electrodes nested arranged in one another (for example known from U.S. Pat. No. 5,481,080 A). But it is also conceivable that rod electrodes are used, for example, two juxtaposed rod electrodes. The electrodes may be made of metal or graphite. In operation of the plasma reactor 1, hydrogen and carbon from hydrocarbons (CₙHₘ) are generated by means of the energy of a plasma. At a high temperature, hydrocarbon fluids, which have been introduced, are decomposed into a mixture of carbon (C particles) and hydrogen (H₂), also referred to as H₂/C aerosol. This mixture of carbon particles and hydrogen remains separated even after cooling. In the vicinity of the electrodes, in particular at the end of the burner parts, a plasma zone 13 is generated by means of an arc between the electrodes, preferably using H₂ as plasma gas, since H₂ is obtained anyway when the hydrocarbons are decomposed. However, any other suitable gas can be selected as plasma gas, for example inert gases such as argon or nitrogen, which do not affect or participate in the reaction or decomposition in the plasma arc. In the plasma zone 13, a plasma is formed in operation, which can be influenced by a plasma controller 14, for example by magnetic force. At the other end of the reactor chamber 2, opposite the plasma torch 7, the plasma reactor 1 has an outlet 15 through which those substances can exit which result from decomposing the introduced hydrocarbon fluid. The outlet 15 is located at an axial end of the reactor chamber 2.

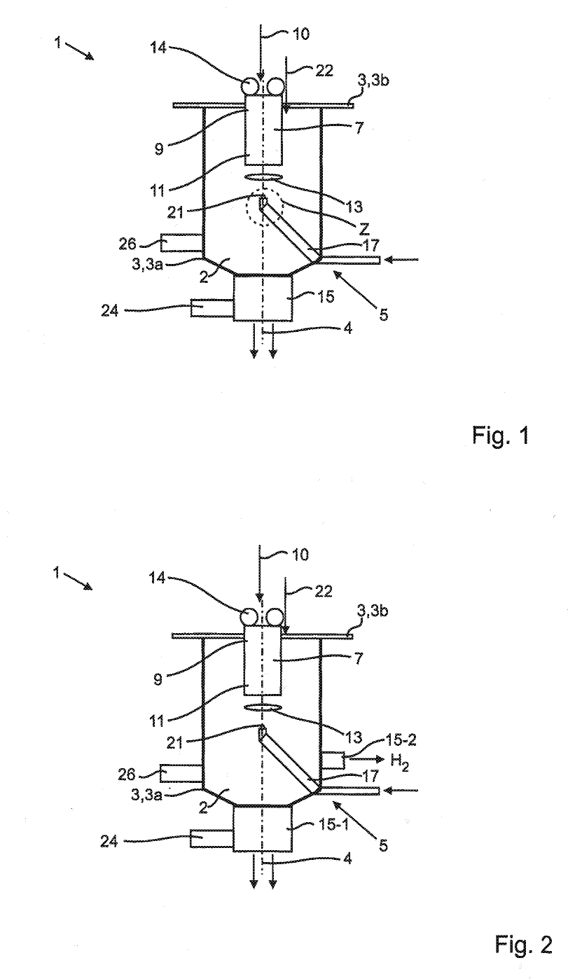

FIG. 2 shows a plasma reactor 1 having a plurality of outlets 15. A first outlet 15-1 is provided for discharging an H₂/C aerosol in the same way as in FIG. 1. A second outlet 15-2 can also be used to discharge a portion of the H₂/C aerosol which shall be used e.g. in another reactor or process. However, preferably only hydrogen H₂ is discharged via the second outlet 15-2, wherein the second outlet 15-2 is configured such that the gaseous hydrogen H₂ separates from the solid C particles. The second outlet 15-2 can be used in all embodiments described here.

Generally speaking, the hydrocarbon inlet 5 is formed by a conduit 7 which is fixed at a first end to the reactor wall 3 (in this case e.g. at the base 3b), and wherein the conduit has at least one discharge opening 21 for hydrocarbon fluid at an opposite end. In a region between the plasma zone 13 and the outlet 15, the hydrocarbon inlet 5 opens into the reactor chamber 2. The discharge opening 21 is oriented toward the plasma zone 3 in such a way that hydrocarbon fluid flowing out of the discharge opening is directed toward the plasma zone 13. Thus, the discharge opening 21 for hydrocarbon fluid is oriented toward the plasma zone. When an outlet direction of the substances resulting from the decomposition of the introduced hydrocarbon fluid (i.e. C particles and H₂) is defined by a line from the plasma zone to the outlet 15, then the hydrocarbon inlet 5 is oriented counter to the outlet direction.

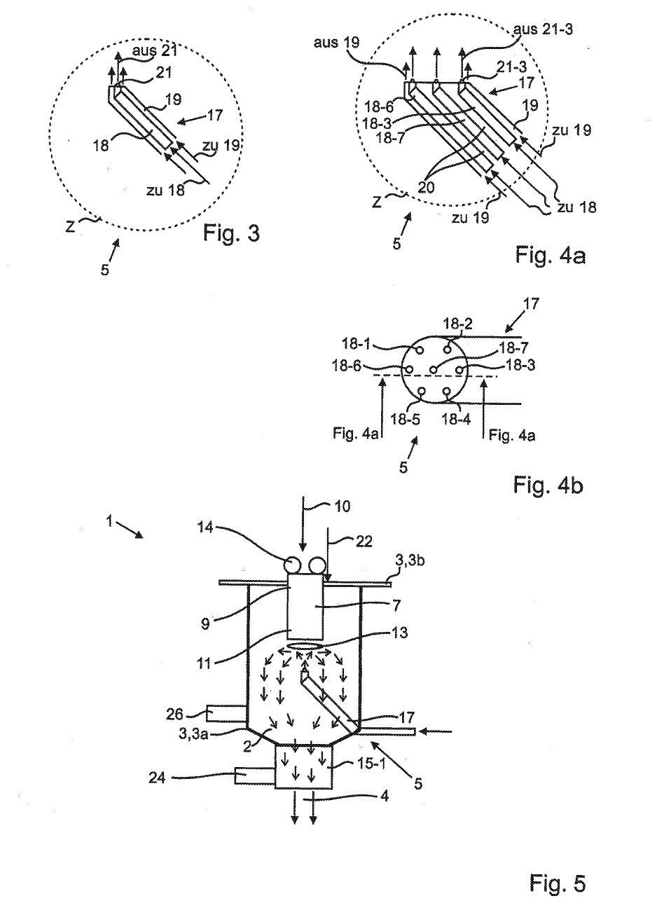

As can be seen in detail in FIG. 3, the conduit 7 according to a simple embodiment has a hydrocarbon conduit 18 and a shielding gas conduit 19. The hydrocarbon conduit 18 and the shielding gas conduit 19 may extend next to each other or may be nested, wherein preferably the hydrocarbon conduit 18 is arranged in the shielding gas conduit 19. Also, the hydrocarbon conduit 18 and the shielding gas conduit 19 may partially extend next to one another and then may be nested close to the discharge opening 21.

According to an alternative embodiment, as shown in the enlarged view of FIGS. 4a and 4b, the hydrocarbon inlet 5 is formed by a bundle of hydrocarbon conduits 18-1, . . . , 18-n. In this case, the hydrocarbon conduits 18-1, . . . , 18-n are surrounded by a common shielding gas conduit 19. Again, the bundle of hydrocarbon conduits 18-1, . . . , 18-n is attached to the reactor wall 3 at a first end, and each hydrocarbon conduit 18-1, . . . , 18-n has a hydrocarbon fluid discharge opening 21-1, . . . , 21-n at an opposite second end. Also in this case, each of the discharge openings 21-1, . . . , 21-n for hydrocarbon fluid is oriented toward the plasma zone 13. The output of hydrocarbon fluid from the individual hydrocarbon conduits 18-1, . . . , 18-n can be controlled separately. Alternatively, each of the hydrocarbon conduits 18-1, . . . , 18-n may be surrounded by its own shielding gas conduit 19 (not shown in the figures), such that the output of shielding gas can also be controlled separately. The hydrocarbon conduits 18-1, . . . , 18-n are optionally cooled by a coolant in one or more coolant conduits 20. Cooling by the coolant conduits 20 prevents the hydrocarbon fluid from being decomposed in an uncontrolled manner, Although the coolant conduits 20 are shown only in FIG. 4a, for ease of illustration, they may be provided in all embodiments. The individual hydrocarbon conduits 18-1, . . . , 18-n have discharge openings 21-1, . . . , 21-n with different flow areas. In this case, an output of hydrocarbon fluid from a first hydrocarbon conduit 18-1 having a first discharge opening 21-1 may be varied by means of valves (not shown) over a first output range of hydrocarbon fluid, and an output of hydrocarbon fluid from a second hydrocarbon conduit 18-2 having a corresponding second discharge opening 21-2 may be varied over a second output range for hydrocarbon fluid. In one example, the first discharge opening 21-1 is used for a different range of output velocities than the second dispensing opening 21-2. In another example, the first dispensing opening 21-1 is used for a different range of mass flow than the second dispensing opening 21-2, The output ranges are different and may be adjacent or overlapping. The first and second output ranges together form a total output range for hydrocarbon fluid. Thus, both the momentum of the generated C particles and the particle size can be varied.

Furthermore, the location and shape of the cloud of hydrocarbon fluid can be varied when the hydrocarbon fluid is dispensed through multiple dispensing openings simultaneously. When a dispensing opening having a large flow area is located in the center of the group of dispensing openings (corresponding to 18-7 in FIG. 4b), the position of the cloud of the hydrocarbon fluid relative to the tips of the electrodes of the burner part 11 may be manipulated. When the feeding pressure of the hydrocarbon fluid is increased, the cloud of hydrocarbon fluid shifts closer to the tips of the electrodes. When the feeding pressure of the hydrocarbon fluid is reduced, the cloud of hydrocarbon fluid moves away from the tips of the electrodes. If, at the same time, hydrocarbon fluid is introduced at the edge (outer region) of the group of dispensing openings, also the shape of the cloud of the hydrocarbon fluid can be influenced, for example approximately round, oval or conical. When the hydrocarbon fluid is introduced at one side of the edge of the group of dispensing openings (corresponding to 18-1, 18-2, 18-3 in FIG. 4b) at a higher pressure than at the other side, the cloud of the hydrocarbon fluid may be moved toward the reactor wall 3 or away therefrom.

In both embodiments, the hydrocarbon conduit(s) 18 or 18-1, . . . , 18-n and the shielding gas conduit 19 are arranged so that in operation an outflowing hydrocarbon fluid is surrounded by a shielding gas. In operation, the output velocity of the shielding gas is significantly less than the output velocity of the hydrocarbon fluid, in particular at least five times lower.

An optional purge gas conduit 22 is arranged in the vicinity of the base part 9 of the plasma torch 7. A curtain of purge gas can be fed between the reactor wall 3 and the plasma torch 7 by means of the purge gas conduit 22. The purge gas may be the same gas that is also used as the plasma gas. The mass flow of the purge gas is less than the mass flow of the hydrocarbon fluid, preferably at least 10 times lower.

In the lower region of the reactor chamber 2 or at the outlet 15, the plasma reactor 1 has a device 24 for measuring a size of the C particles of the H₂/C aerosol. Devices for measuring a particle size are known and are described, for example, in: Leschonski, Kurt “Grundlagen und moderne Verfahren der Partikelmesstechnik”, Institut für mechanische Verfahrenstechnik und Umweltverfahrenstechnik, Technische Universitat Clausthal, 1988 (engl. “Fundamentals and Modern Methods of Particle Measurement”, Institute of Mechanical Process Engineering and Environmental Process Engineering, Clausthal University of Technology, 1988). Various measuring methods can be used, and the device 24 may be one of the following, for example: a differential mobility classifier (DEMC), a differential mobility spectrometer (DE-MAS, Engl. Differential Mobility Analyzing System) or a laser diffraction analyzer, but is not limited to these. Since the temperature in the lower portion of the reactor chamber 2 or at the outlet 15 (or 15-1, 15-2) is over 700° C., it is considered that a portion of the H₂/C aerosol or C particles is extracted, is cooled and measured thereafter.

Furthermore, the plasma reactor 1 comprises a pressure sensor 26 which is arranged in connection with the reactor chamber 2 and is adapted to sense the pressure in the reactor chamber 2, i.e. the back pressure. The pressure sensor 26 is arranged, for example, in the lower region of the reactor chamber 2 in order to protect the pressure sensor from the direct influence of the plasma. For example, the pressure sensor 26 may be located at approximately the same distance from the plasma torch 7 (measured along the central axis 4) as the distance where the conduits 17, 18, 19 for hydrocarbon and shielding gas are attached to the reactor wall 3. The plasma reactor 1 further includes a second pressure sensor (not shown) which can sense the pressure of the hydrocarbon fluid upstream of the dispensing opening 21 or 21-1, . . . , 21-n, i.e. the upstream pressure.

The operation of the plasma reactor 1 will be described below. Hydrocarbon fluid is introduced through the hydrocarbon conduit 18 in the direction toward the plasma zone 13. Individual hydrocarbon molecules can not penetrate the high-viscosity plasma, as has been shown by experiments and calculations. Due to the high temperature of the plasma, the hydrocarbon fluid on the way to the plasma zone 3 is first decomposed into product gas (C atoms and H atoms). At the same time, C particles (carbon black particles—a kind of graphite) form from the C atoms. This process takes about 8 to 12 ms. Then, one or more parameters of the introduction of hydrocarbon fluid are varied, in particular (a) a flow area of the hydrocarbon inlet (thereby, the flow rate of the hydrocarbon fluid can be varied at a constant mass flow; and, alternatively, the mass flow can be changed at a constant flow rate); (b) a pressure difference between a pressure in the reactor chamber and a pressure of the hydrocarbon fluid at a position upstream of the hydrocarbon inlet (thereby, the mass flow and the flow velocity can be changed, in particular finely adjusted); or (c) a flow velocity of the hydrocarbon fluid at the hydrocarbon inlet (the flow velocity may be influenced by changing the flow area of the hydrocarbon inlet or by changing the mass flow). These operating parameters have an influence on the size of the C particles and their momentum. By continuously measuring the particle size of the carbon particles by means of the device 24, a correlation between a particle size of the C particles and the at least one parameter of the introduction of hydrocarbon fluid may be determined. The operation of the plasma reactor 1 is controlled by a controller (not shown), and the correlation between the particle size and the operating parameters is stored in a map in a memory of the controller.

The parameters for the introduction of hydrocarbon fluid are controlled such that the particle size of the C particles is minimal so as to avoid hard or solid deposits. In addition, small C particles can be processed better. Small C particles are particularly advantageous when the C particles shall be converted to CO, for example, when the plasma reactor 1 is used as a hydrocarbon converter in a device for producing CO or synthesis gas. Devices for producing CO or synthesis gas are described, for example, in WO 2013/09 878 A1 and WO 2013/091879 A1, In addition to the plasma gases mentioned above, CO or synthesis gas can be used as plasma gas in such devices. Further, a plasma reactor 1 having a plurality of outlets 15-1 and 15-2 (FIG. 2) is advantageous for a device for generating CO or synthesis gas, since a portion of the hydrogen can be discharged via the second outlet 15-2, and the ratio of CO to H₂ can be altered.

Furthermore, a pressure difference between (i) a pressure of the hydrocarbon fluid at a position upstream of the hydrocarbon inlet and (ii) a pressure in the reactor chamber or a pressure at a position downstream of the outlet is continuously sensed, and a sudden change in the sensed pressure difference is detected. The pressure at a position downstream of the outlet 15 is related to the pressure inside the reactor chamber 2. A significant change in the pressure or in pressure gradient in the reactor chamber is an indication that the product gas described above is generated from C atoms and H atoms and that the desired flow of product gas toward the wall of the reactor chamber occurs. The size of the C particles generated from the C atoms of the product gas has a somewhat statistic distribution. That is, very large C particles (or very small C particles) cannot be completely avoided. However, the flow of most of the product gas toward the wall of the reactor chamber ensures that predominantly small C particles are produced from this part of the product gas. The measurement of the pressure difference and the measurement of the particle size can be carried out independently. Preferably, the measurement of the pressure difference is used as a support to improve the accuracy and speed of the control.

In operation, the pressure in the reactor chamber 2 and the temperature outside the plasma zone 13 are kept slightly below the sublimation conditions of graphite. For example, the pressure in the reactor chamber 2 is maintained at about 20 bar (+/−10%), and the temperature outside the plasma zone 13 is kept below 3900° C., so that the C particles do not sublime and condense on the reactor wall 3.

In operation of the embodiment of FIGS. 4a and 4b, where the hydrocarbon inlet 5 is formed by a bundle of hydrocarbon conduits 18-1, . . . , 18-n, the output of hydrocarbon fluid from the hydrocarbon conduits 18-1, . . . , 18-n is separately controlled over different output ranges. As mentioned above, the output of hydrocarbon fluid can be varied over a wide range, that is with respect to e.g. the mass per time, the pressure, the flow velocity. The output velocity and the difference between the upstream pressure or pre-pressure and the back pressure of the first dispensing opening 21-1 are varied to introduce hydrocarbon in a first range of the mass flow into the reactor chamber 2. The size of the second dispensing opening 21-2 is adapted for a different range of mass flow, and accordingly the dispensing velocity and the difference between the upstream pressure and the back pressure are varied in a corresponding other range. Likewise, the size of the third dispensing opening 21-3 is again adapted for another range of mass flow, and so on. For example, the parameters for introducing the hydrocarbon fluid may be varied for the output ranges of the dispensing openings 21-1, . . . , 21-n, as shown in the following Table 1:

| | | Difference of | Flow | Mass flow |
|---|---|---|---|---|
| | | upstream | area of the | of the |
| Dispensing | Output | pressure to | dispensing | hydrocarbon |
| opening | velocity | back pressure | opening | fluid |
| 21-1 | v_{21-1,min} to | Δp_{21-1,min} to | a1 | m_{21-1,min} to |
| | v_{21-1,max} | Δp_{21-1,max} | | m_{21-1,max} |
| 21-2 | v_{21-2,min} to | Δp_{21-2,min} to | a2 | m_{21-2,min} to |
| | v_{21-2,max} | Δp_{21-2,max} | | m_{21-2,max} |
| 21-3 | v_{21-3,min} to | Δp_{21-3,min} to | a3 | m_{21-3,min} to |
| | v_{21-3,max} | Δp_{21-3,max} | | m_{21-3,max} |
| 21-4 | v_{21-4,min} to | Δp_{21-4,min} to | a4 | m_{21-4,min} to |
| | v_{21-4,max} | Δp_{21-4,max} | | m_{21-4,max} |
| 21-5 | v_{21-5,min} to | Δp_{21-5,min} to | a5 | m_{21-5,min} to |
| | v_{21-5,max} | Δp_{21-5,max} | | m_{21-5,max} |
| 21-6 | v_{21-6,min} to | Δp_{21-6,min} to | a6 | m_{21-6,min} to |
| | v_{21-6,max} | Δp_{21-6,max} | | m_{21-6,max} |
| 21-7 | v_{21-7,min} to | Δp_{21-7,min} to | a7 | m_{21-7,min} to |
| | v_{21-7,max} | Δp_{21-7,max} | | m_{21-7,max} |

The output ranges are adjacent and differ from each other, i.e. the velocity range v_{21-1,min} to v_{21-1,max} of the dispensing opening 21-1 adjoins the velocity range v_{21-2,min} to v_{21-2,max} of the next dispensing opening 21-2, and so on until 21-7. Further, the range of the pressure difference Δp_{21-1,min} to Δp_{21-1,max} between the upstream pressure and the back pressure of the dispensing opening 21-1 adjoins the range of the pressure difference Δp_{21-2,min} to Δp_{21-2,max} of the next dispensing opening 21-2, and so on until 21-7. Similarly, the range m_{21-1,min} to m_{21-1,max} of the mass flow from the dispensing opening 21-1 adjoins the range m_{21-2,min} to m_{21-2,max} of the mass flow from the dispensing opening 21-2, and so on until 21-7. The adjoining or adjacent output ranges of the dispensing openings 21-1, . . . , 21-7 together form an entire output range in which the output can be varied with respect to flow velocity, mass flow and pressure difference without interrupting the operation. The output ranges of the dispensing openings 21-1, . . . , 21-n may also be partially over-lapping so that a smooth transition between the dispensing openings 21-1, . . . , 21-n is possible.

If the mass flow of the hydrocarbon fluid shall remain the same when the hydrocarbon inlet 5 is considered in its entirety, a plurality of hydrocarbon conduits 18-1, . . . , 18-n can be used simultaneously, wherein, starting from an initial number of hydrocarbon conduits 18-1, . . . , 18-n, the hydrocarbon fluid is supplied into the reactor chamber 2 via one or more hydrocarbon conduits 18-1, . . . , 18-n additionally or less. For example, the hydrocarbon fluid is first dispensed from the dispensing openings 21-1, . . . , 21-n of four hydrocarbon conduits 18-1, . . . , 18-n with a first pressure difference. Then, the hydrocarbon fluid is first supplied from the dispensing openings 21-1, . . . , 21-n of five hydrocarbon conduits 18-1, . . . , 18-n with a second pressure difference, wherein the mass flow remains the same regardless of how many hydrocarbon conduits 18-1, . . . , 18-n the hydrocarbon fluid flows toward the plasma zone 13.

A prolonged uninterrupted operation of the plasma reactor 1 can be achieved in the following manner irrespective of whether the hydrocarbon inlet 5 has a single hydrocarbon conduit 18 or a plurality of hydrocarbon conduits 18-1, . . . , 18-n. First, hydrocarbon fluid is supplied toward the plasma zone 13. The heat decomposes the hydrocarbon fluid, and C particles and hydrogen are generated. The C particles continue to flow toward the plasma zone 13 because of the orientation of the hydrocarbon inlet 5 and because of their momentum. As mentioned above, according to the inventor's calculations, the decomposition of the hydrocarbon fluid and formation of C particles take about 8-12 ms (9 ms on the average). In a concrete example, a fluid flowing hydrocarbon conduits 18-1, . . . , 18-n at a flow velocity v=100 m/s needs 10 ms to reach the plasma zone 13 when the hydrocarbon inlet 5 (i.e. the dispensing openings 21-1, . . . , 21-n) is 1 m away from the plasma zone. According to the inventors' calculations, the decomposition of the hydrocarbon fluid and the growth of the complete C particles take about 9 ms in this case. Therefore, although C particles reach the plasma zone 13, the plasma forms a barrier to the C particles. In order to penetrate the plasma zone 13, a minimum energy (momentum) is necessary. When penetrating into the plasma zone 13, small C particles are slowed down more than large C particles, since a proportionately larger portion of the momentum loss must come from the proportion of the velocity. The operating temperature in the plasma reactor 1 is 2500 to 3500° C. between the arc at the burner part 11 and the reactor wall 3, wherein the temperature decreases in the direction to the reactor wall 3, The sublimation temperature of graphite (C particles) is about 3800° C. Since the temperature in the plasma zone 13 is approximately 5000 to 15000° C., the C particles continuously sublimate after entering the plasma zone 13 with reformation to atomic carbon (C atom).

The parameters for introducing the hydrocarbon fluid are therefore controlled such that large C particles are generated. The parameters for the introduction are set, for example, based on the characteristic map in the memory of the controller of the plasma reactor 1. A size distribution of the carbon particles is influenced e.g. by means of the following parameters of the output of hydrocarbon fluid: flow area of the hydrocarbon inlet; pressure difference between (i) a pressure of the hydrocarbon fluid at a position upstream of the hydrocarbon inlet and (ii) a pressure inside the reactor chamber or a pressure downstream of the outlet; flow velocity of the hydrocarbon fluid at the hydrocarbon inlet. Further, the size of the C particles can be measured by means of the device 24 for measuring the particle size. Controlling the flow velocity of the hydrocarbon fluid from the hydrocarbon inlet 5 (i.e. the dispensing opening(s) 21 or 21-1, . . . , 21-n) is particularly advantageous. From the flow velocity v and the mass m of the hydrocarbon a momentum is calculated according to p=m·v, wherein the momentum can be varied by means of the flow velocity v. Since the hydrocarbon is decomposed so as to form C atoms, and since the total momentum p=m·v is equal to the sum of the individual momenta (p=Σnᵢ pᵢ=n_{c} p_{c}+h_{H2} p_{H2}) according to the law of conservation of momentum, the momentum of a single C atom does not depend on the type of hydrocarbon fluid but on the flow velocity v: =m_{c} v. The mass of one C atom is a constant, and the momentum of a C particle is additively composed of the momenta of all the C atoms of which the C particle consists: momentum of a C particle having n C atoms: p_{C-particle}=n m_{C-atom} v. Thus, the momentum of a C particle depends only on the number of carbon atoms (i.e. the particle size) and the flow velocity v.

The parameters for introducing the hydrocarbon fluid are controlled based on the map such that at least a portion of the C particles is sufficiently large to penetrate the plasma zone 13 and to migrate toward the electrodes of the plasma torch 7. Overall, the number and size of the C particles (and the total number of carbon atoms comprised therein) is subject to a statistical distribution function, wherein all C particles have a velocity dependent on the flow velocity from the dispensing openings 21-1, . . . , 21-n. By setting the parameters for introducing or supplying the hydrocarbon fluid (in particular the flow velocity v), the statistical distribution function of the size of the C particles can be influenced such that a small portion of the C particles is sufficiently large and has sufficient kinetic energy (momentum) to enter into and pass through the plasma zone 13. Although these sufficiently large C particles are subject to sublimation in the plasma zone 13, some of these C particles deposit on the electrode and compensate for erosion.

For the penetration of the plasma zone and the impact on the electrode ends, the particle size is not the sole decisive parameter, but also the momentum of the particles. Therefore, a definite particle size can not be specified. As a guide, it can be assumed that a small particle has a diameter of less than 20 nm, a medium particle has a diameter of 20 nm to 60 nm, and a large particle has a diameter of more than 60 nm (>60 nm). Small C particles can not enter the plasma zone 13. Although medium C particles can penetrate into the plasma zone 13, they are slowed down considerably. The small and medium-sized C particles sublimate to C atoms and flow laterally to the reactor wall 3, wherein the C atoms again form small C particles upon cooling. Since the entire H₂/C aerosol cools down consistently, no “cold methane” grows on existing C particles (such as in WO 93/20152).

As a result of the orientation of the hydrocarbon inlet 5 (i.e. the dispensing opening(s) 21 or 21-1, . . . , 21-n), the large C particles with high kinetic energy can penetrate into and break through the plasma zone 13, while at the same time small and medium-sized C particles transform into very small C particles after sublimation at or in the plasma zone 13. Thus, the size of the C particles, which flow laterally toward the reactor wall 3 and down to the outlet 15, is smaller than in the case of known plasma reactors, namely in the range of less than 50 nm in diameter, preferably less than 30 nm in diameter. Further, the thickness of the deposition of the carbon on the electrode ends and the time of introducing hydrocarbon fluid are measured.

The flow velocity v, at which the hydrocarbon fluid is introduced, is adjusted such that the deposition of the carbon on the electrode ends is as fast as the erosion of the electrode due to the sublimation of the carbon. The resistance that the plasma gas brings to the C particles depends on the composition of the plasma gas, on the flow velocity thereof, on its viscosity (temperature, degree of ionization) and on its extent (reactor design, mass flow per unit time). It should be noted that for a given plasma reactor 1 there is not a fixed flow velocity of the hydrocarbon where the deposition of carbon on the electrode is always equal to erosion by sublimation. This balance depends on many secondary parameters that can be varied independently. For example, the power of the electrode (the supplied amount of current in MW and thus the energy supplied by the electrode into the plasma reactor 1) can be increased significantly if the carbon deposition on the electrode is correspondingly increased. The increased rate of sublimation of the electrode material, which is increased due to the increase in electrical power, is compensated by a higher carbon deposition, and the electrode remains virtually free of erosion. By means of targeted deposition of C particles on the electrode, it is thus possible not only to increase the service life of the electrode but at the same time also to increase the capacity of the plasma reactor 1.

It should be noted that the methods described herein may be practiced regardless of whether the hydrocarbon inlet 5 comprises a single hydrocarbon conduit 18 or a multitude of hydrocarbon conduits 18-1, . . . , 18-n. In an embodiment having a plurality of hydrocarbon conduits 18-1, . . . , 18-n, it is possible to separately control at least one parameter of the output of hydrocarbon fluid from the hydrocarbon conduits, in particular: a flow area of the hydrocarbon inlet 5 (by switching between the hydrocarbon conduits 18-1, . . . , 18-n or by using more than one hydrocarbon conduit 18-1, . . . , 18-n); a pressure difference between (i) a pressure at a position upstream of the hydrocarbon inlet 5 (i.e. before the dispensing openings 21-1, . . . , 21-n), and a pressure inside the reactor chamber 2 or a pressure at a position after the outlet 15 and/or a flow velocity v of the hydrocarbon fluid at the hydrocarbon inlet 5 (i.e. at the dispensing openings 21-1, . . . , 21-n). Furthermore, the following relationship applies to all of the methods described herein, regardless of whether a single hydrocarbon conduit 18 or a plurality of hydrocarbon conduits 18-1, . . . , 18-n are provided:

m=60·π·v·(d/2)²

where:

m=mass flow (m³/min) from one dispensing opening 21 or 21-1, . . . , 21-n

v=output velocity (m/s)
d=diameter of one dispensing opening 21 or 21-1, . . . , 21-n

The invention has been described with reference to preferred embodiments, wherein the individual features of the described embodiments can be freely combined with each other and/or can be replaced, provided that they are compatible. Likewise, individual features of the described embodiments can be omitted, unless they are absolutely necessary. Numerous modifications and embodiments are possible and conceivable to those skilled in the art without departing from the inventive concept.

1-17. (canceled)

18. A plasma reactor (1) for decomposing a hydrocarbon fluid, comprising:
a reactor chamber (2) surrounded by a reactor wall (3, 3a, 3b) and having at least one hydrocarbon inlet (5) and one outlet (15);
a plasma torch (7) having at least two electrodes, which have a base part (9) fixed to the reactor wall (3, 3a, 3b) at a first end and which have at a second end a burner part (11), which projects into the reactor chamber (2), and wherein a plasma zone (13) is defined at the end of the burner parts (11) of adjacent electrodes;
wherein the hydrocarbon inlet (5) opens into the reactor chamber (2) in a region between the plasma zone and the outlet (15); and
wherein the hydrocarbon inlet (5) is oriented toward the plasma zone (13) such that outflowing hydrocarbon fluid is directed toward the plasma zone (13) wherein the hydrocarbon inlet (5) is formed by a bundle of hydrocarbon conduits (18-1, . . . , 18-n), wherein the bundle of hydrocarbon conduits (18-1, . . . , 18-n) is attached to the reactor wall (3, 3a, 3b) at a first end, and wherein each hydrocarbon conduit (18-1, . . . , 18-n) has a dispensing opening (21-1, 21-n) for hydrocarbon fluid at an opposite second end; and wherein the individual hydrocarbon conduits (18-1, . . . , 18-n) comprise dispensing openings (21-1, . . . , 21-n) having a flow area of different size; wherein the bundle of hydrocarbon conduits (18-1, . . . , 18-n) is shaped such that each of the dispensing openings (21-1, . . . , 21-n) for hydrocarbon fluid is oriented toward the plasma zone; and
wherein an output of hydrocarbon fluid from the individual hydrocarbon conduits (18-1, . . . , 18-n) of the bundle is separately controllable by means of valves.

19. The plasma reactor (1) according to claim 18, wherein an outlet direction is defined by a line from the plasma zone (13) to the outlet (15), and wherein the hydrocarbon inlet (5) is oriented opposite to the outlet direction.

20. The plasma reactor (1) according to claim 18, wherein the hydrocarbon inlet (5) is formed by a conduit (17, 18), which is fixed to the reactor wall (3, 3a, 3b) at a first end and which has a dispensing opening (21) for hydrocarbon fluid at an opposite one second end; and wherein the conduit (17, 18) is shaped such that the dispensing opening (21) for hydrocarbon fluid is oriented toward the plasma zone (13).

21. The plasma reactor (1) according to claim 18, wherein an output of hydrocarbon fluid from a first hydrocarbon conduit (18-1) having a first dispensing opening (21-1) is controllable by means of valves over a first output range (v_{21-1,min}-v_{21-1,max}; Δp_{21-1,min}-Δp_{21-1,max}; m_{21-1,min}-m_{21-1,max}) for hydrocarbon fluid, and
wherein an output of hydrocarbon fluid from least one second hydrocarbon conduit (18-2, . . . , 18-n) having a corresponding second dispensing opening (21-2, . . . , 21-n) is controllable by means of valves over at least one second output range (v_{21-2,min}-v_{21-2,max}; Δp_{21-2,min}-Δp_{21-2,max}; m_{21-2,min}-m_{21-2,max}) of hydrocarbon fluid,
wherein the at least one second output region is at least partially different from the first output region for hydrocarbon fluid; and
wherein the first output region and the at least one second output region cooperatively constitute a total output range (v_{21-1,min}-v_{21-n,max}; Δp_{21-1,min}-Δp_{21-n,max}; m_{21-1,min}-m_{21-n,max}) for hydrocarbon fluid of the hydrocarbon inlet (5).

22. The plasma reactor (1) according to claim 18, comprising a device (24) for measuring a particle size.

23. The plasma reactor (1) according to claim 18, comprising a pressure sensor (26) adapted to sense the pressure in the reactor chamber (2).

24. A method for operating a plasma reactor (1) for decomposing a hydrocarbon fluid, wherein the plasma reactor (1) comprises a reactor chamber (2) which is surrounded by a reactor wall (3, 3a, 3b) and comprises at least one hydrocarbon inlet (5) and an outlet (15); wherein a plasma torch (7) having at least two electrodes is disposed in the reactor chamber (2), and wherein a plasma zone (13) is defined at the end of adjacent elongated electrodes; the method comprising the steps of:
introducing hydrocarbon fluid toward the plasma zone (13) into a region of the reactor chamber (2) between the plasma zone (13) and the outlet (15), and decomposing the hydrocarbon fluid into carbon particles and hydrogen;
varying at least one parameter of introduction of hydrocarbon fluid;
determining a correlation between a particle size of the carbon particles and the at least one parameter of introduction of hydrocarbon fluid during the step of varying, wherein the correlation is determined by continuously measuring the particle size is and, at the same time, individually varying operating parameters, and creating a map which represents the relationship between the particle size and the varied operating parameters.

25. The method according to claim 24, wherein the parameter of introduction of hydrocarbon fluid is at least one of the following:
a flow area of the hydrocarbon inlet (5);
a pressure difference between
a pressure of the hydrocarbon fluid at a position upstream of the hydrocarbon inlet (5) and
a pressure in the reactor chamber (2) or a pressure downstream of the outlet (15); and
a flow velocity of the hydrocarbon fluid at the hydrocarbon inlet (5).

26. The method according to claim 25, wherein the plasma torch (7) is provided with graphite electrodes, and wherein the supply of electrical energy to the graphite electrodes and the pressure for the introduction of the hydrocarbon fluid are controlled such that the temperature at the tip is hotter than 2800° C. but colder than 3900° C., preferably below 3800° C.

27. The method according to claim 24, comprising the step of controlling the at least one parameter of the introduction of hydrocarbon fluid based on the determined correlation such that the particle size of the carbon particles is minimal.

28. The method according to claim 24, comprising:
sensing a pressure differential between
a pressure of the hydrocarbon fluid at a position upstream of the hydrocarbon inlet (5) and
a pressure in the reactor chamber (2) or a pressure at a position downstream of the outlet (15);
detecting a sudden change in the sensed pressure difference.

29. The method according to claim 24, which comprises maintaining the pressure in the reactor chamber (2) and the temperature outside the plasma zone slightly below the sublimation conditions of graphite, in particular maintaining the pressure in the reactor chamber (2) at 20 bar and keeping the temperature outside the plasma zone below 3800° C.

30. The method according to claim 24, wherein the hydrocarbon inlet (5) is formed by a bundle of hydrocarbon conduits (18-1, . . . , 18-n), the bundle of hydrocarbon conduits (18-1, . . . , 18-n) being attached to the reactor wall (3, 3a, 3b) at a first end, and wherein each of the hydrocarbon conduits (18-1, . . . , 18-n) has a dispensing opening (21-1, . . . , 21-n) for hydrocarbon fluid at an opposite second end; wherein the dispensing openings (21-1, . . . , 21-n) for hydrocarbon fluid are oriented toward the plasma zone (13) and have dispensing openings (21-1, . . . , 21-n) with different flow areas; and
wherein the method comprises the step of separately controlling the output of hydrocarbon fluid from the hydrocarbon conduits (18-1, . . . , 18-n).

31. The method according to claim 30, wherein the hydrocarbon inlet (5) comprises a bundle of at least N hydrocarbon conduits (18-1, . . . , 18-n), and wherein the method comprises the steps of:
a) introducing a hydrocarbon fluid from the dispensing openings of N hydrocarbon conduits, wherein a first pressure difference exists between a pressure of the hydrocarbon fluid at a position upstream of the hydrocarbon inlet (5) and a pressure in the reactor chamber (2) or a pressure at a position downstream of the outlet (15);
b) introducing a hydrocarbon fluid from the dispensing openings of N−1 or N+1 hydrocarbon conduits, wherein a second pressure difference exists between a pressure of the hydrocarbon fluid at a position upstream of the hydrocarbon inlet (5) and a pressure in the reactor chamber (2) or a pressure at a position downstream of the outlet (15), wherein the second pressure difference is greater than the first pressure difference; and wherein the mass flow of the hydrocarbon fluid in steps a) and b) is the same.

32. The method according to claim 7, further comprising:
the steps of affecting a distribution of the size of the carbon particles based on the correlation such that a small portion of the carbon particles is sufficiently large to travel through the plasma zone (13); depositing a portion of the carbon particles on the electrode ends;
measuring the time of introduction of hydrocarbon fluid and the thickness of the deposition of the carbon particles on the electrode ends; and modifying the flow velocity at which the hydrocarbon fluid is introduced, such that the deposition of the carbon on the electrode ends occurs as rapidly as the erosion of the electrode due to sublimation of the carbon.
